(19) United States
(12) Patent Application Publication
(10) Pub. No.: US 2021/0236385 A1
(43) Pub. Date: Aug. 5, 2021

(54) TRANSFER DEVICE WITH USER-CONTROLLED VENTING

(71) Applicant: Yukon Medical, LLC, Durham, NC (US)

(72) Inventors: Thomas J. Fraites, JR., Durham, NC (US); Stanton D. Batchelor, Durham, NC (US); Todd M. Korogi, Durham, NC (US)

(73) Assignee: Yukon Medical, LLC, Durham, NC (US)

(21) Appl. No.: 17/160,530

(22) Filed: Jan. 28, 2021

Related U.S. Application Data
(60) Provisional application No. 62/967,991, filed on Jan. 30, 2020.

(51) Int. Cl. A61J 1/20

(52) U.S. Cl. CPC A61J 1/2048; A61J 1/2089; A61J 1/2075; A61J 1/2086; A61J 1/2013

(57) ABSTRACT

A vial access device comprising an first housing comprising a vent body having a cover configured for reversibly hermetically sealing the vent body; a first spike having a proximal end and a distal end, the proximal end projecting from the first housing, the first spike having a fluid lumen and a vent lumen, each arranged parallel to the first longitudinal axis, the vent lumen in fluidic communication with the vent body; a shroud projecting the first housing and at least partially surrounding a portion of the first spike; the shroud configured to receive a vial or container; a connector member projecting from the first housing, the connector in fluid communication with the fluid lumen of the first spike. Methods of transferring solutions from medicament vials are also provided.

### CROSS-REFERENCE TO RELATED APPLICATIONS

This application claims the benefit of U.S. Provisional Application No. 62/967,991 filed on Jan. 30, 2020, the entirety of which is incorporated herein by reference.

### TECHNICAL FIELD

The present disclosure relates generally to transfer devices for use with medicinal substances. More particularly, the disclosure concerns a vial access device for connecting with a vial or container and to allow mixing and/or transfer of a fluid, the device capable of user-controlled venting during transfer from the vial or container.

### BACKGROUND

Liquid drugs are typically provided in medicament vials with standard elastomeric closure sizes, such as 20 mm and 13 mm diameter closures. Vial access devices are used to withdraw medication from these vials. Transfer of medicament from one vial to another typically involves using a vial under reduced pressure, for example, vacuum. Upon mixing, such configurations may result in undesirable “hang up” of liquid in one vial due to lack of air displacement. While transfer devices with venting are known, such devices cannot be used with drug vials that are under reduced pressure.

### SUMMARY

In a first embodiment, an access device is provided, comprising a first housing comprising: a vent body having a cover configured for reversibly hermetically sealing the vent body; a first spike having a proximal end and a distal end, the proximal end projecting from the first housing, the first spike having a fluid lumen and a vent lumen, each arranged parallel to the first longitudinal axis, the vent lumen in fluidic communication with the vent body; a shroud projecting the first housing and at least partially surrounding a portion of the first spike; the shroud configured to receive a vial or container; a connector member projecting from the first housing, the connector in fluid communication with the fluid lumen of the first spike.

In another example, the access device further comprises: a second housing reversibly receivable by the connector member, the second housing comprising a second spike having a proximal end and a distal end, the proximal end projecting from the second housing, the second spike having a lumen arranged parallel to a first longitudinal axis, the second spike configured to be in fluid communication with the fluid lumen when the second housing is received by the connector member; a shroud projecting from the second housing and at least partially surrounding a portion of the second spike; the shroud configured to receive a vial or container.

In another example, alone or in combination with any one of the previous examples, the vent lumen is fluidically isolated from the fluid lumen. In another example, alone or in combination with any of the previous examples, the vent body comprises a vent filter. In another example, alone or in combination with any one of the previous examples, the first housing further comprises a fluid filter body comprising a fluid filter in fluidic communication with the fluid lumen.

In another example, alone or in combination with any one of the previous examples, the fluid filter body in fluid communication with the fluid connector, the fluid filter body having a fluid filter surface substantially parallel to the direction of fluid flow through the fluid connector.

In another example, an access device is provided, the access device comprising a first housing comprising: a vent body having a cover configured for reversibly hermetically sealing the vent body; a first spike having a proximal end and a distal end, the proximal end projecting from the first housing, the first spike having a fluid lumen and a vent lumen, each arranged parallel to the first longitudinal axis, the vent lumen in fluidic communication with the vent body; a shroud projecting the first housing and at least partially surrounding a portion of the first spike; the shroud configured to receive a vial or container; a connector member projecting from the first housing, the connector in fluid communication with the fluid lumen of the first spike; and: a second housing reversibly received by the connector member, the second housing comprising a second spike having a proximal end and a distal end, the proximal end projecting from the second housing, the second spike having a lumen arranged parallel to a first longitudinal axis, the second spike in fluid communication with the fluid lumen; a shroud projecting from the second housing and at least partially surrounding a portion of the second spike; the shroud configured to receive a vial or container.

In another example, a method of transferring liquid between a first container and a second containers is provided, the method comprising: providing an access device as defined in any one of previously described examples, where the cover is in a hermetically sealed configuration with the vent body; establishing fluidic communication between the first container and the second container, where at least one of the first container and the second container contains a medicament; reconstituting the medicament; and manipulating the cover to an unsealed configuration with the vent body.

In one example, the first container or the second container is under reduced pressure. In another example, alone or in combination with any one of the previous examples, the first container or the second container comprises a reconstitutable or lyophilized medicament.

In another example, alone or in combination with any one of the previous examples, the method further comprising disconnecting the first housing from the second housing, before or after manipulating the cover to the unsealed configuration. In another example, alone or in combination with any one of the previous examples, the method further comprises connecting the connector of the first housing to a drug delivery device, IV bag, or IV line, before or after manipulating the cover to the unsealed configuration.

In another example, alone or in combination with any one of the previous examples, the access device further comprises a fluid filter body comprising a fluid filter in fluidic communication with the fluid lumen. In another example, alone or in combination with any one of the previous examples, the method further comprising filtering the medicament.

### BRIEF DESCRIPTION OF THE DRAWINGS

FIG. 1A Is a perspective view of a vial access device shown fully assembled in a first state, as disclosed and described herein.

FIG. 1B Is an perspective view of the vial access device of FIG. 1A, in a second state, as disclosed and described herein.

FIG. 2 is section view of the embodiment of FIG. 1A shown along section plane 2-2.

FIG. 3A is a perspective view of another embodiment of a vial access device with fluid filtering, as disclosed and described herein.

FIG. 3B is an exploded view of the device of FIG. 3A.

FIG. 3C is a side view of the vial access device of FIG. 3A, showing sectional plane 3D-3D.

FIG. 3D is section view of the embodiment of FIG. 3A shown along section plane 3D-3D.

FIG. 4 is an exploded view of an exemplary packaging construction for the device of FIG. 1A, as disclosed and described herein.

FIG. 5 is a top plan view of the packaging construction of FIG. 4 with section line 6-6.

FIG. 6 is a section view of the packaging construction of FIG. 4 along section line 6-6, as disclosed and described herein.

FIG. 7 is an enlarged view of a portion of FIG. 6.

FIG. 8A is a perspective view depicting dispensing of the device for engagement with a container, as disclosed and described herein, from its packaging.

FIG. 8B is a perspective view depicting the dispensing of the device from its packaging with engagement with the container, as disclosed and described herein.

FIG. 9A is a perspective view of the vial access device embodiment of FIG. 1A shown operatively connected to a container.

FIG. 9B is a perspective view of the vial access device embodiment of FIG. 1A shown operatively connected to two containers.

FIG. 10 is top view of FIG. 9B with sectional plane 11-11.

FIG. 11 is a section view of the access device of FIG. 9B along sectional plane 11-11

FIG. 12 is a perspective view of a portion of the vial access device of FIG. 1A coupled to a container and operatively connected to a syringe.

FIG. 13 is a perspective view of a portion of the vial access device of FIG. 1A shown coupled to a container and operatively to an intravenous line (IV line).

### DETAILED DESCRIPTION

A vial access device of the type disclosed and described comprising a controllable vent element. The vial access device is inexpensive to produce and adds minimal additional assembly cost or tooling complexity. Thus, the present disclosure provides a vial access device that is of a simple construction, can easily be used and inexpensively manufactured in large quantity. These and other features of the present disclosure are provided by the vial access device that will be described in the paragraphs that follow with reference to the drawings.

As used herein, the terms “fluid” or “fluidic” are inclusive of liquids, gases, and mixtures thereof.

The presently disclosed vial access device provides for securing to container such as vials and allowing access and/or mixing and/or transference of substances contained within the containers to form a mixture, suspension, or solution and for removal of the resultant mixture, suspension, or solution with controlled venting for subsequent administration to a subject.

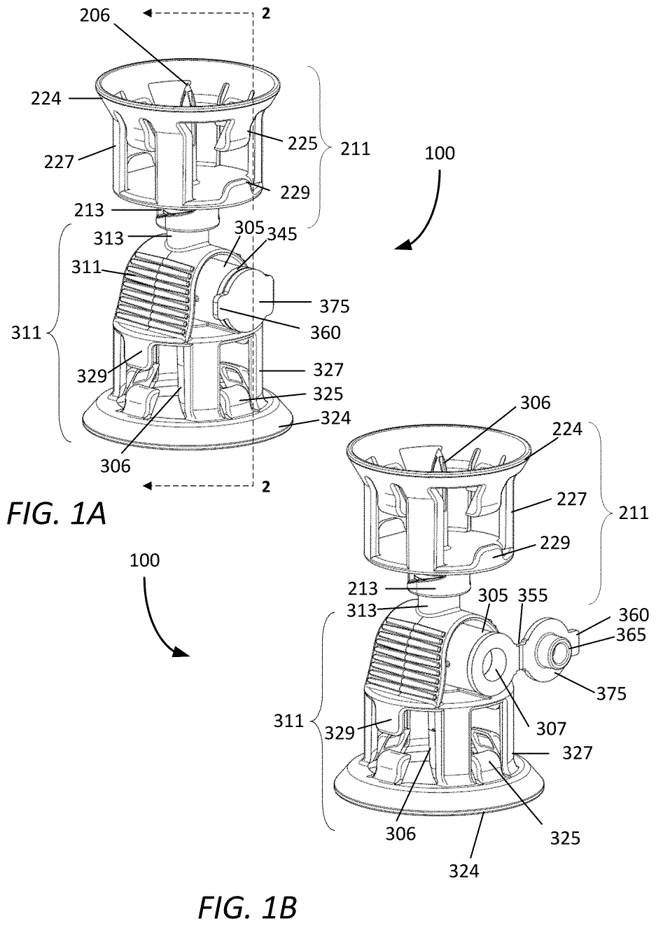

Referring to FIGS. 1A and 1B, perspective views of exemplary device 100, are shown in a fully assembled state where the controlled venting is in a first state, and where the controlled venting is in a second state, respectively, discussed in more detail below.

Exemplary access device 100, with a controllable vent cover 375, is provided where the device comprises an first housing 311 that has a first spike 306 projecting from the housing, the spike comprising at least two lumen (e.g., a vent and fluid lumen), the first spike 306 configured for penetration of an container closure element, such as a pierceable septum of a medicament vial, and for providing fluid communication through a first connector 313 releaseably connected to a second connector 213 of a second housing 211. Connectors 213, 313 can be a luer fitting or other small-bore connector.

In one example, the upper and the second housing are releaseably connected using male/female luer connectors. In one example, as shown, the first housing 311 has a male luer connector 313 and the second housing 211 has a female luer connector 213. In another example, the first housing 311 has a female luer connector and the second housing 211 has a male luer connector. In addition to providing connection to the respective upper and second housings, the first and the second connectors provide for separation of the respective upper and lower housings of device 100 and for independent connection of the respective housings to fluid delivery devices such as syringes, intravenous lines, and/or intravenous bags. In one example, the cross sectional area of the fluid path of connectors 213, 313 does not change significantly over this span so as not to inhibit flow or create pressure gradients within the device.

The second housing 211 has a second spike 206 having at least one lumen (e.g., a fluid lumen), the second spike configured for penetration of an container closure element, such as a pierceable septum of a medicament vial, and for providing fluid communication with the first spike 306 of the first housing 311 through the second connector 213 and first connector 313.

Each of the first housing 311 and the second housing 211 has a projecting wall or shroud 324, 224 at least partially surrounding the first spike 306 and the second spike 206, respectively. Shroud 324, 224 projects from respective housings 311, 211 via vertical posts 327, 227 respectively. Other shroud configurations can be used. In one example, the respective shrouds 324, 224 have features 325, 225, respectively, projecting inwards towards the spike to hold a vial or container. In another example, shrouds 324, 224 have anti-snagging features 329, 229 configured for manufacturing convenience so as to avoid entanglement of features 325, 225 of independent devices. Shrouds 324,224 can, independently, be configured for adapting to and securing conventional 13 mm and 20 mm medicament vials, respectively or they can be configured for adapting to and securing vials of the same size.

Controllable vent cover 375 is configured to form a seal with vent body 305 via wall 345. In one example, both vent body 305 and wall 345 are shaped and dimensioned such that a leak-tight and airtight seal is formed there between. Wall 345 includes an opening 307 to form a seal with wall 365 of vent cover 375. In one example, opening 307 and wall 365 are shaped and dimensioned such that a leak-tight and airtight seal is formed there between. As shown, vent body 305, opening 307, wall 345, and wall 365 are annular or tubular shaped, however, other shapes can be used. Vent body 305, opening 307, wall 345, and wall 365 can be tapered.

Vent cover 375 is configured to transition from a first state, where wall 365 is in a leak-tight and airtight relationship with opening 307, to a second state, where wall 365 is dislodged from opening 307 such that a fluidic pathway is created between opening 307 and vent lumen 328 of first spike 306. In one example, transition of vent cover 375 from the first state to the second state is reversible. In another example, transition of vent cover 375 from the first state to the second state is irreversible. Hinge 355 of vent cover 375 is configured to allow transition of vent cover 375 from the first state to the second state. Tab feature 360 allows a user to easily transition vent cover 375 from the first state to the second state, for example, using a finger or thumb of one hand.

In one example, first housing 311 includes anti-airlock feature (not shown), e.g., preventing airlock if fluid enters void space between vent filter 304 and vent lumen 328. For example, if the vent becomes flooded, extending the orifice height with anti-airlock feature aids in evacuating the fluid in an inverted orientation. In another example, fluid lumen 312 has its opening in spike 306 vertically transposed from opening in vent lumen 328, such that when device 100 is engaged with a container and inverted, the opening in vent lumen is above the liquid level of the container whereas the opening in fluid lumen 312 is configured to be below the liquid level and configured to receive liquid adjacent the septum of the container such that a maximum amount of liquid can be transferred from the container through spike 306.

Vent body 305 can be constructed of a rigid plastic such as polycarbonate, polypropylene, cyclic olefinic copolymer, etc. Wall 345 and wall 365 can be constructed of polyethylene, polyethylene copolymers, polypropylene, polypropylene copolymers, or thermoplastic elastomer. In one example, wall 345 and wall 365 are constructed of the same material which is softer and more pliable (lower durometer) than that body 305.

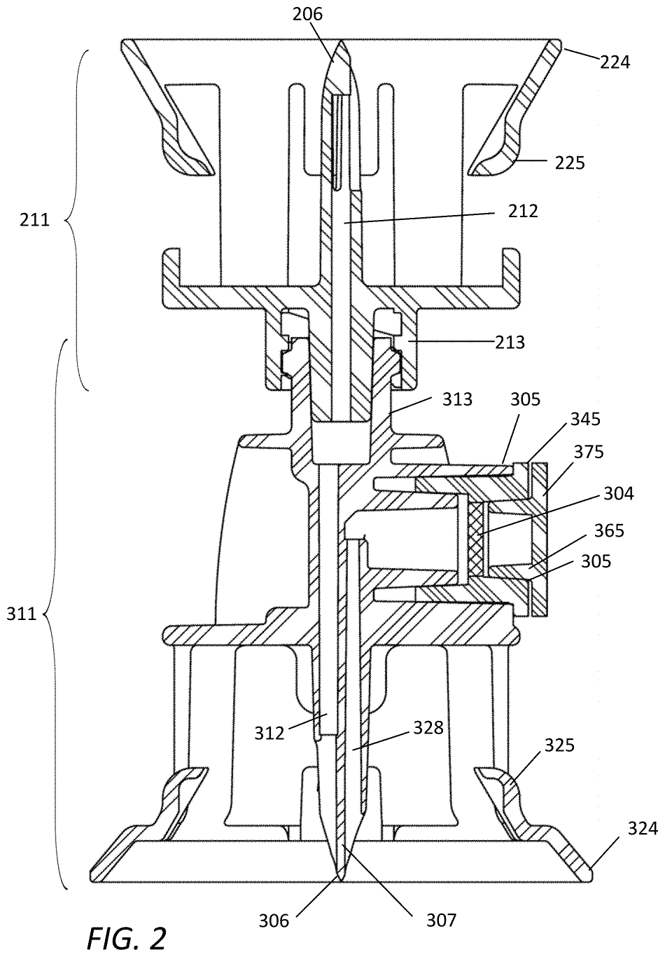

FIG. 2 is a section view along section line 2-2 showing first housing 311 and second housing 211 reversibly coupled via connectors 313, 213, respectively, providing fluidic communication between fluid lumen 312 of first spike 306 and fluid lumen 212 of second spike 206. Vent body 305 of first housing 311 receives wall 345 which receives wall 365 of vent cover 375 in the first state, providing a sealed relationship. Fluidic communication between vent lumen 328 and the ambient is controlled via vent cover 375, where in the first state fluidic access to ambient is sealed off through vent body 305 and opening 307, where in the second state, fluidic access to the ambient is provided through vent body 305 and opening 307.

Also shown with vent body 305 is optional vent filter 304. Vent filter 304 can consist of any appropriate material, micron porosity, hydrophobicity, and efficiency for a given application. A typical range of micron porosity for an vent filter is between 0.02 uM and 150 uM (micron). In one aspect, vent filter 304 is disk-shaped. Other shapes can be used for the vent filter 304.

Particulate may be present in the vial or become mixed in the medication during the fluid removal/transfer process. Types of particles that may be present in vials include; pharmaceutical sediment, lipids, un-dissolved solids, crystallization of medication elements, glass, plastic and rubber debris, septum particulate and various other types of contaminants. These particles can be various sizes and shapes, and depending on the medicament, hydrophobic and/or hydrophilic, and/or partially or completely ionized salts. In addition, insertion of the vial access spike can shear off or core bits of the stopper of the vial. Often these particles are sub-visible sizes and will go unnoticed. Particulates that are injected into a patient can cause complications, for example, phlebitis, organ damage, and vessel blockage. This presents a technical problem alone or in combination with the need for controlled venting.

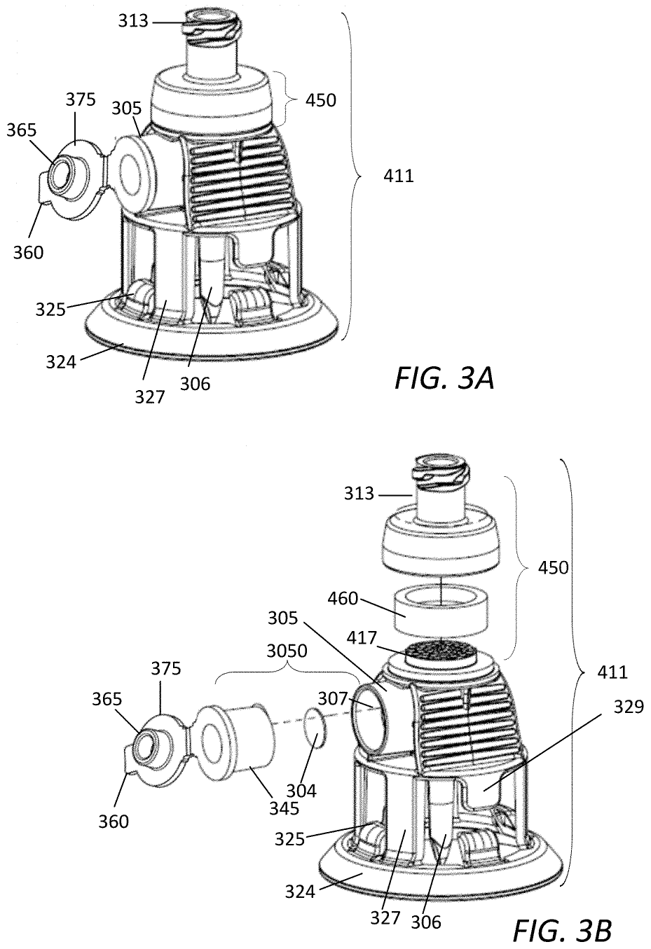

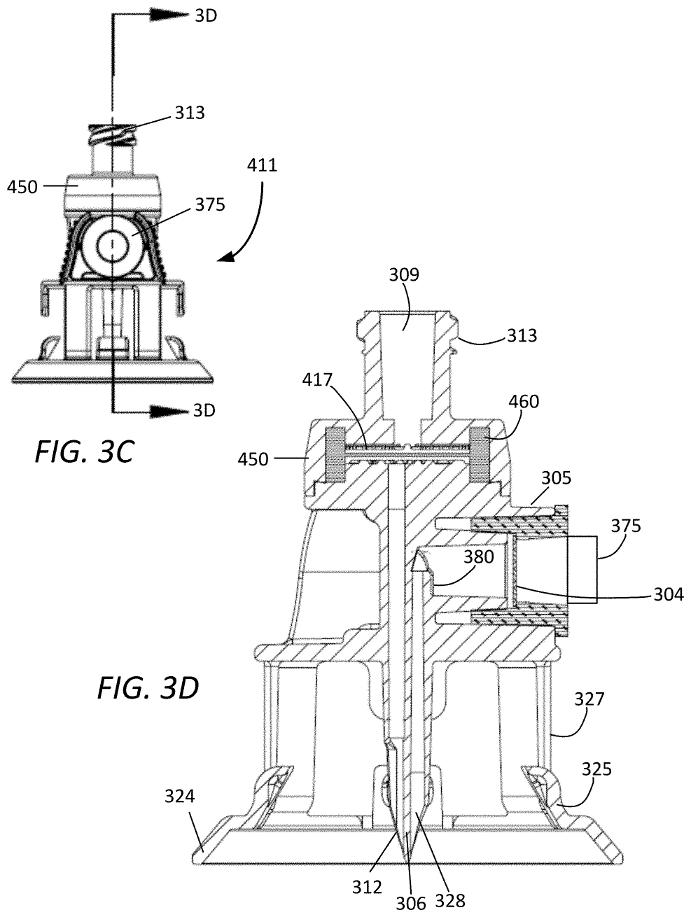

Thus, a technical solution to the above technical problem is addressed by the present disclosure with reference to FIGS. 3A, 3B, 3C and 3D, showing a perspective view, exploded view, side view, and a section view of the side view along section line 3D-3D, respectively, of an exemplary first housing 411, disconnected from second housing 211 of device 100 having fluid filtering functionality. First housing 411 differs from first housing 311 of device 100 with the addition of a liquid fluid filter body 450 and fluid filter 417 configured for receiving and filtering fluid. The fluid filter body 450 is shown with a pair of securing surfaces for receiving and retaining fluid filter 417. FIG. 3B is an exploded perspective view showing fluid filter housing 450 comprising fluid filter 417, retaining element 460, assembled with fluid filter housing 450 configured to receive retaining element 460 and fluid filter 417. Connector member 313 projects from first housing 450 for providing fluid communication in a manner similar to that of device 100. Also shown is an exploded view of vent assembly 3050 comprising vent body 305, vent filter 304, wall 345 received by opening 307 of vent body 305, vent cover 375, wall 365 and tab 360.

FIG. 3C is a side view of first housing 411 and FIG. 3D is a side cross section view of the housing along section line 3D-3D. Previously described vent body 305 has vent filter 304 surface that is arranged essentially perpendicular to fluid filter 417 surface in the assembled device. Liquid filter 417 is arranged to receive and filter fluid through lumen 312 of spike 306. In one example, the fluid filter body 450 comprises a first fluid conduit arranged non-parallel to the longitudinal axis of the spike and a second fluid conduit substantially parallel with the first conduit and in fluid communication with connecter 313. Positioned between the fluid lumen 312 and the first fluid conduit of the fluid filter body is a fluid filter 417 having a front and a back surface, the front surface arranged to be essentially parallel to the longitudinal axis of the flow of fluid from the spike lumen 312. Air vent body 305 is in fluidic communication with vent lumen 328 for aspirating and/or venting with the ambient and an optional vent filter 304. In one example, optional vent filter 304 has a front surface and a back surface, the front surface arranged essentially parallel to the spike 306.

Vial access spike 306 of first housing 411 provides a fluid path 312 from spike 306, through fluid filter 417 and into fluid conduit 309 through fluid filter housing 450. In one aspect, fluid from a vial or connector is presented to a front surface of fluid filter 417, the front face being substantially perpendicular to the direction of fluid flow and substantially perpendicular to the longitudinal axis of spike 306. Spike 306 of first housing 411 includes vent lumen 328 communicating with vent filter body 305, filter 304, and ambient. Thus, as shown, a face of fluid filter 417 is substantially perpendicular to a face of vent filter 304. In one example, first housing 411 includes element 380 providing for clearing the vent, e.g., preventing airlock if fluid enters void space between vent filter 304 and vent lumen 328. For example, if the vent becomes flooded, extending the orifice height with element 380 aids in evacuating the fluid in an inverted orientation.

Fluid filter 417 of housing 411 can consist of any appropriate material, micron porosity and efficiency for a given application. A typical range of micron porosity for a fluid filter is between about 0.2 uM and about 15 uM (micron). In one aspect, fluid filter 417 can be disk-shaped. Other shapes can be used for fluid filter 417. In one aspect, fluid filter 417 can be disk-shaped. Vent filter 304 of housing 411 can consist of any appropriate material, micron porosity and efficiency for a given application. A typical range of micron porosity for an vent filter is between 0.02 uM and 150 uM (micron).

During use of device 100 with housing 411, the direction of fluid flow is generally to/from fluid lumen 312 of spike 306 to conduit 309. A force to urge flow is created, e.g., by a syringe attached to connector member 313. Connector member 313 can be a luer fitting or other small-bore connector. The cross sectional area of the fluid path does not change significantly over this span so as not to inhibit flow or create pressure gradients within the device. Fluid filter 417 separates particulates from the fluid under induced flow. Fluid filter body 450 can be generally annular in shape, square, rectangular, oval, etc., provided it is configured to form an air tight seal via various means including press fit, solvent bond, adhesive bond, ultrasonic bond, and/or via an additional elastomeric element such as an o-ring.

The fluid filter 417 may be attached to the fluid filter body 450 via adhesive, ultrasonic welding or insert molding. Alternately the fluid filter 417 may be held in place by a compression fit. Alternately, the fluid filter 417 may be attached to the retaining element 460.

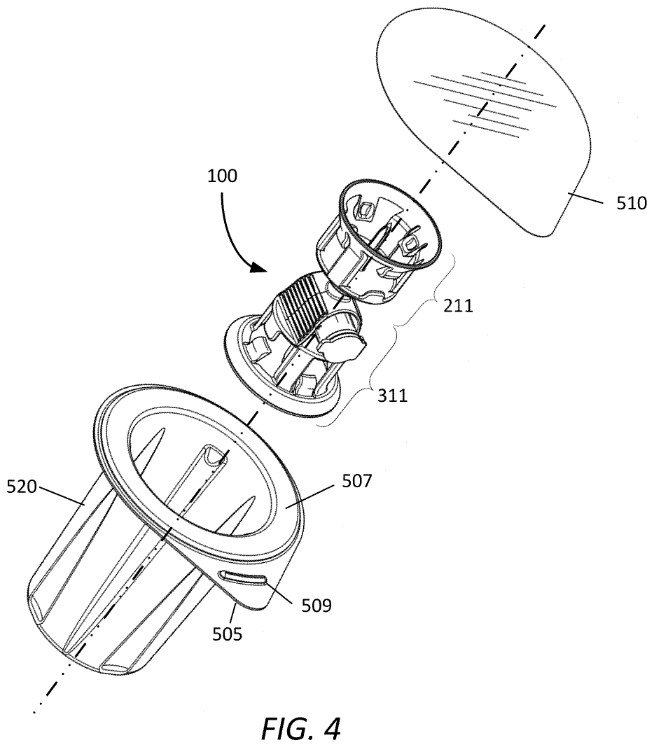

With reference to FIG. 4, exemplary device 100 is shown in combination with optional functional packaging comprising packaging container 520 being closed at one end and opened with annular surface 507 at the opposing end, packaging container 520 being dimension to receive first housing 311 or 411 of device 100 for positioning at the closed end and second housing 211 adjacent to opened end. Annular surface 507 is configured to receive lid 510 thus forming a hermetic seal about device 100 for aseptic assembly or radiation based sterilization techniques. Annular surface 507 includes planar projection 505 with relief 509 for ease of removal of the lid 510.

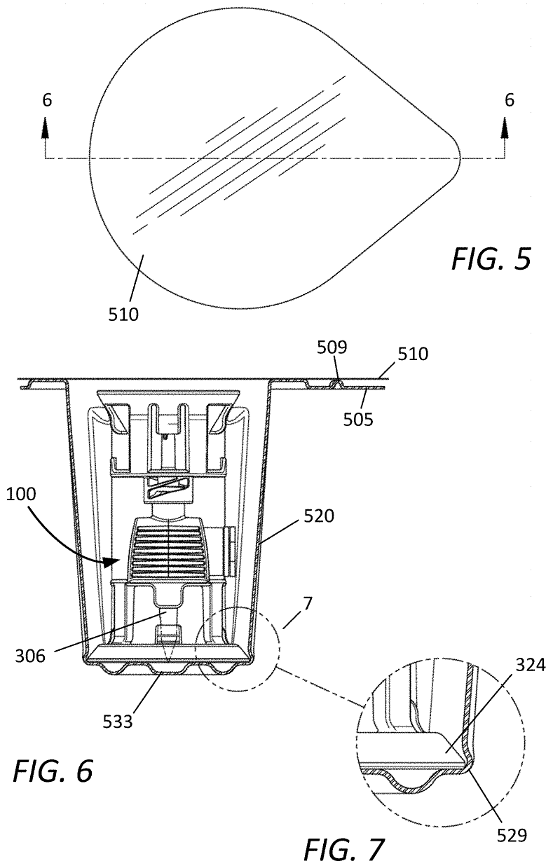

With reference to FIG. 5-7, lid 510 is shown with section line 6-6. FIG. 6 is a section view along section line 6-6 of functional packaging comprising device 100 shown arranged with second housing 211 adjacent opening of packaging container 520 and first housing 311 or 411 distal from opening. Exploded view 7 depicted in FIG. 7 shows annular ring shaped shroud 324 secured by undercut section 529 of tapered wall of packaging container 520. Packaging container 520 also comprises annular feature 533 dimension to receive distal end of spike 306 that extends beyond annular ring shaped shroud 324 preserving the tip of spike 306 for penetrating septums, etc.

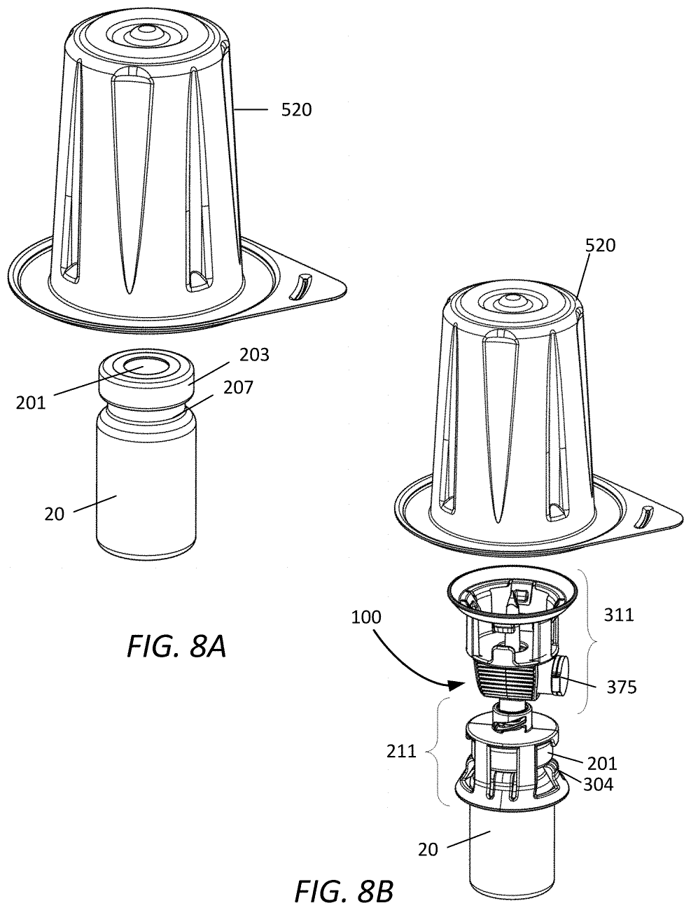

In using the access device 100 (with first housing 311 or 411), reference is now made to FIGS. 8A-8B, where vial 20 is attached to second housing 211 of vial access device 100 while still in packaging container 520 by inverting packaging container 520 after removing lid 510. Vial 20 includes an upper, generally cylindrically shaped “necked” or tapered portion 207 terminating in pierceable septum 201 crimped in place by band 203, for example, of 13 mm or 20 mm diameter. Upon engagement of vial access device 100 with vial 20, spike 206 penetrates septum 201 of vial 20 and accesses the interior of vial 20. Vial 20 is securely held to second housing 211 by features 325 of shroud which engage the septum crimping band 203 adjacent tapered neck portion 207 of the vial. In this configuration, contents of the vial 20 is accessible for transfer through fluid lumen 212 of spike 206. In one example, the contents of vial 20 contains diluent such as saline, Ringers solution, or other liquid and/or suspension or dispersion intended to be combined with another medicament, substance, or liquid. Packaging container 520 can be removed from device 100, which allows first housing 311 or 411, with vent cover 375 in a sealed configuration with opening 307 of vent body 305, to be attached to another container, e.g., vial 21, so as to allow fluidic communication between vial 20 and the other container, via fluid lumen 312 of first housing 311 or 411 and fluid lumen 212 of second housing 211.

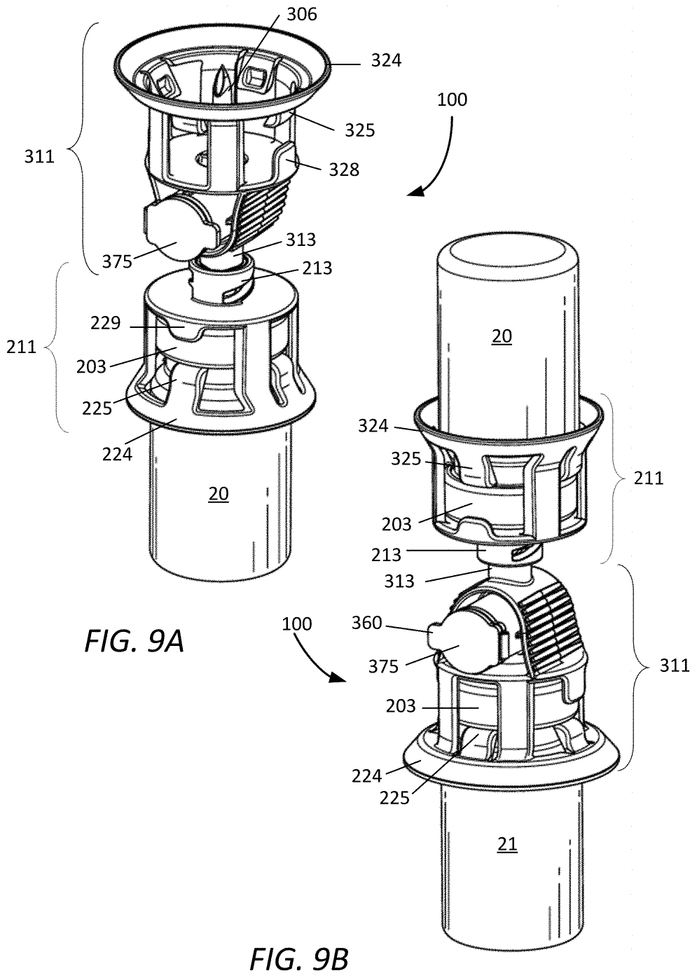

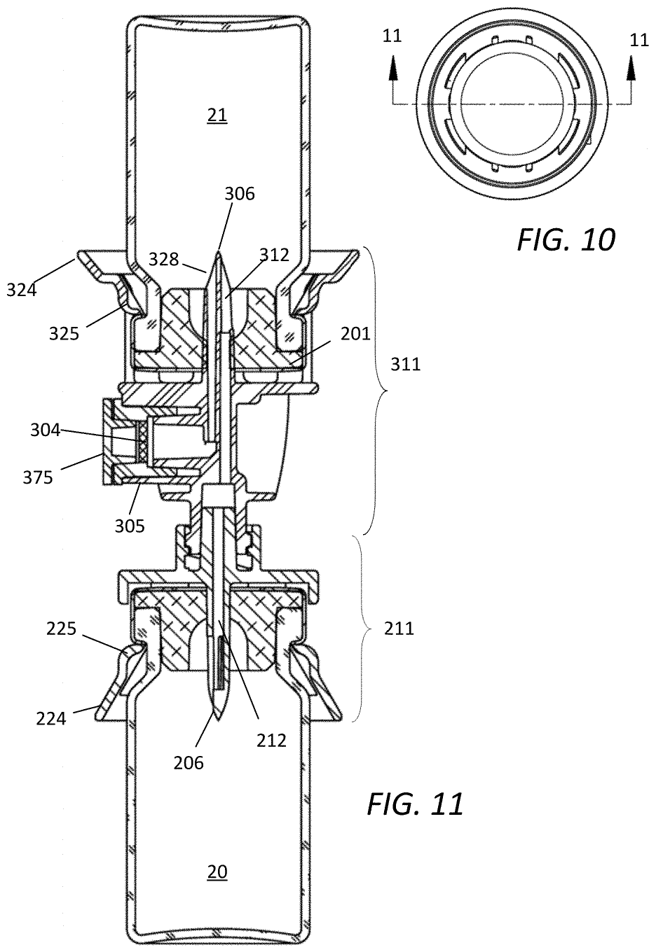

With reference to FIGS. 9A-9B and FIGS. 10 and 11, the other container is exemplified by second vial 21 and is attached to first housing 311 or 411 in a similar manner to that of vial 20 attachment to second housing 211 described above. In one example, second vial 21 contains medicament held under reduced atmospheric pressure. FIG. 9B shows inversion of device 100. FIG. 11, which is a section view of FIG. 10, shows fluid communication path between vials 21 and 20 via fluid lumen 312 of first housing 311 and fluid lumen 212 of second housing 211. In one example, reduced atmospheric pressure of vial 21 urges diluent of vial 20 to enter vial 21 for reconstituting, mixing, or diluting medicament contained therein.

In one example, after sufficient reconstituting, mixing, or diluting of medicament has taken place, first housing 311 or 411 is disconnected from second housing 211 and attached to a drug delivery device and subsequently, vent cover 375 is manipulated to an unsealed configuration, i.e., transitioned to the second state, opening a vent to allow for aspiration of vial 21 via vent lumen 328 of spike 306 and vent body 305 with optional vent filter 304. In another example, first housing 311 or 411 is disconnected from second housing 211, vent cover 375 is opened, and subsequently, first housing 311 or 411 is attached to a drug delivery device. In another example, first housing 311 or 411 is disconnected from second housing 211, first housing 311 or 411 is attached to a drug delivery device, and subsequently, vent cover 375 is opened.

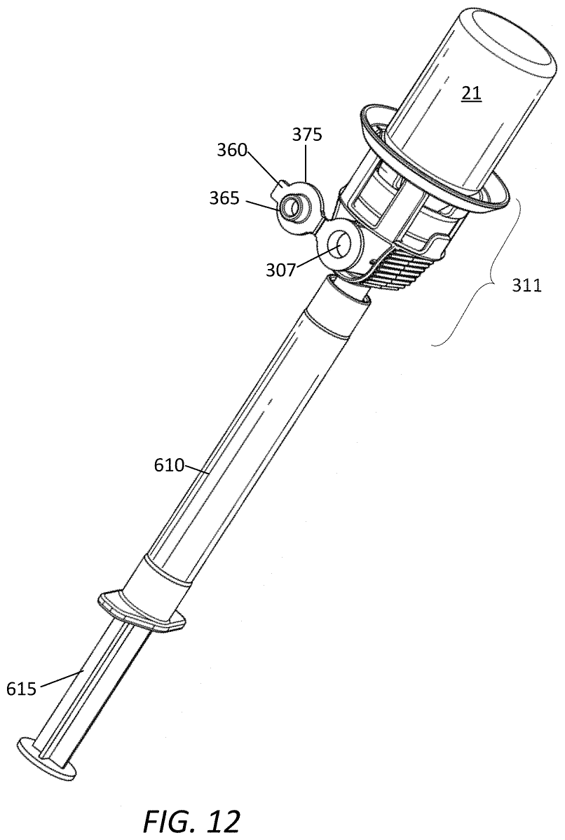

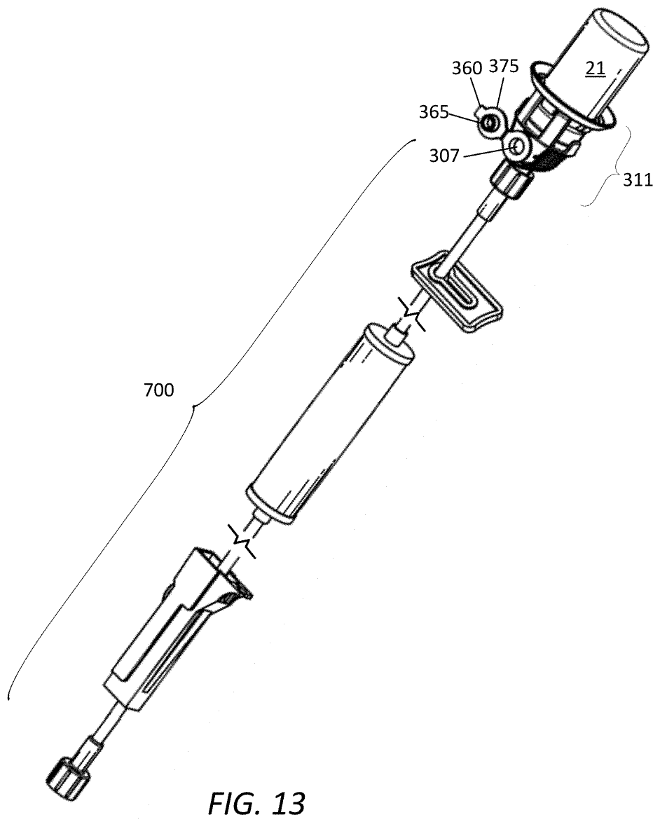

With reference to FIGS. 12 and 13, once fluid is introduced to medicament in vial 21 and sufficient reconstituting, mixing, or diluting of medicament has taken place, and second housing 211 is removed from device 100, connection of first housing 311 (or 411) to a delivery device is performed. For example, contents of vial 21 can be withdrawn into volume 610 of syringe, e.g. by withdrawing plunger rod 615 of syringe. Likewise, first housing 311 together with reconstituted medicament of vial 21 can be coupled to IV set 700, the vent cover 375 brought into the second state to allow for aspiration and drug delivery to a subject.

Valve means, for example, flow control devices, can be integral or connectable to the connector member 313 of first housing 311 or 411 so as to control fluid flow through the device. Such fluid control devices can include split septums, collapsible septums, valved male/female luers, stopcocks, and the like.

We claim:

1. A vial access device comprising
an first housing comprising:
a vent body having a cover configured for reversibly hermetically sealing the vent body;
a first spike having a proximal end and a distal end, the proximal end projecting from the first housing, the first spike having a fluid lumen and a vent lumen, each arranged parallel to the first longitudinal axis, the vent lumen in fluidic communication with the vent body;
a shroud projecting the first housing and at least partially surrounding a portion of the first spike; the shroud configured to receive a vial or container; and
a connector member projecting from the first housing, the connector in fluid communication with the fluid lumen of the first spike.

2. The device of claim 1, further comprising:
a second housing reversibly receivable by the connector member, the second housing comprising
a second spike having a proximal end and a distal end, the proximal end projecting from the second housing, the second spike having a lumen arranged parallel to a first longitudinal axis, the second spike configured to be in fluid communication with the fluid lumen when the second housing is received by the connector member; and
a shroud projecting from the second housing and at least partially surrounding a portion of the second spike; the shroud configured to receive a vial or container.

3. The device of claim 1, wherein the vent lumen is fluidically isolated from the fluid lumen.

4. The device of claim 1, wherein the vent body comprises a vent filter.

5. The device of claim 1, wherein the first housing further comprises a fluid filter body comprising a fluid filter in fluidic communication with the fluid lumen.

6. The vial access device of claim 5, wherein the fluid filter body in fluid communication with the fluid connector, the fluid filter body having a fluid filter surface substantially parallel to the direction of fluid flow through the fluid connector.

7. A vial access device comprising:
a first housing comprising:
a vent body having a cover configured for reversibly hermetically sealing the vent body;
a first spike having a proximal end and a distal end, the proximal end projecting from the first housing, the first spike having a fluid lumen and a vent lumen, each arranged parallel to the first longitudinal axis, the vent lumen in fluidic communication with the vent body;
a shroud projecting the first housing and at least partially surrounding a portion of the first spike; the shroud configured to receive a vial or container; and
a connector member projecting from the first housing, the connector in fluid communication with the fluid lumen of the first spike; and:
a second housing reversibly received by the connector member, the second housing comprising
a second spike having a proximal end and a distal end, the proximal end projecting from the second housing, the second spike having a lumen arranged parallel to a first longitudinal axis, the second spike in fluid communication with the fluid lumen; and
a shroud projecting from the second housing and at least partially surrounding a portion of the second spike; the shroud configured to receive a vial or container.

8. A method of transferring liquid between sealed vials, the method comprising:
providing a vial access device as defined in claim 7, where the cover is in a hermetically sealed configuration with the vent body;
establishing fluidic communication between the sealed vials, at least one of the sealed vials being under reduced pressure and comprising a reconstitutable medicament;
reconstituting the medicament; and
manipulating the cover to an unsealed configuration with vent body cover.

9. The method of claim 8, further comprising disconnecting the first housing from the second housing, before or after manipulating the cover to the unsealed configuration.

10. The method of claim 9, further comprising connecting the connector of the first housing to a drug delivery device, IV bag, or IV line, before or after manipulating the cover to the unsealed configuration.

11. The method of claim 8, wherein the vial access device further comprises a fluid filter body comprising a fluid filter in fluidic communication with the fluid lumen.

12. The method of claim 11, further comprising filtering the medicament.
